(19) United States
(12) Patent Application Publication
(10) Pub. No.: US 2004/0103723 A1
(43) Pub. Date: Jun. 3, 2004

(54) Sensor with identification unit

(76) Inventor: Paul Kirschbaum, Seiersberg (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/664,041

(22) Filed: Sep. 17, 2003

(30) Foreign Application Priority Data
Oct. 4, 2002 (AT) GM 663/2002

(51) Int. Cl. G01L 9/06

(52) U.S. Cl. 73/727

(57) ABSTRACT

A sensor (1) is provided in the region of the connecting socket (3) for the connecting cable (5) with an integrated identification unit (6) which can be electrically queried and contacted through a separate pole of the connecting cable (5), on the one hand, and through the cable shield of the connecting cable (5), on the other hand, whereby the sensitivity of the sensor (1) can be coded and queried from the outside via the connecting cable (5) by means of the identification unit (6).

### BACKGROUND OF THE INVENTION

1. Field of the Invention

The invention relates to a sensor having an identification unit that can be queried electrically through a connecting cable.

2. The Prior Art

Sensors of the aforementioned type or measuring arrangements having sensors of such type are disclosed in AT 5,042 U2, for example, and they are employed in the most diverse connections. These sensors are today specialized and used individually in conjunction with research and development projects so that accurate and individual matching of the connected evaluation unit with the respective sensor is unavoidable to ensure relevant measuring results at all.

There is a great number of sensor-relevant data which is to be absolutely considered to correctly perform measurements as, for example, in conjunction with piezo-electric or piezo-resistive sensors used for determination or monitoring of pressure in various production processes or on test benches or the like. For example, this data includes measuring range, sensitivity or similar data, and it must be correspondingly taken into consideration in the use of the sensors or its integration into the respective measuring arrangement. From the above-mentioned AT 5,042 U2 is disclosed in this connection to arrange outside of the sensor a memory unit for extensive data, individually characterizing the respective sensor, and to provide in or on the sensor itself merely one identification unit having sensor recognition that can be correlated with the memory unit. Only a small amount of identification data of the sensor can remain connected physically with the sensor in a permanent manner—for example in simple, robust, passive-electric components, such as a resistor having a known value—while other extensive sensor-relevant data, such as sensitivity curves, calibration data and the like are provided in an exterior memory unit whereby there is only necessary the checking of simple sensor recognition for association of the memory unit to ensure association of the memory unit with the sensor.

Aside of the above-mentioned division of sensor-relevant data, there can be sufficient for the respective application, of course, the simple identification of the sensor itself (e.g. for assignment to a separately established data table) or the availability of individual data directly identifying the respective sensor (as, for instance, of the measuring range or the sensitivity) whereby finding can be accomplished with only a small amount of data existing in the electrically interrogatable identification unit in or on the sensor itself.

It is the object of the present invention to design a sensor of the aforementioned type whereby the identification unit can be placed in the sensor in a simple and robust manner and whereby the identification unit can be contacted or queried from the outside.

### SUMMARY OF THE INVENTION

This object is achieved according to the present invention in that the identification unit is integrated in the sensor in the region of the connecting socket for the connecting cable whereby the identification is contacted through a separate pole of the connecting cable, on the one hand, and through the cable shield of the connecting cable, on the other hand. The connecting cable is made thereby of double-pole, shielded cables. One pole serves for measuring-value transmission of the measuring element in the sensor (e.g. for transmission of the charge of the piezo signal in case of a piezo-electric pressure sensor) and the second pole serves to contact the identification unit whereby the cable shield serves both poles or the signal lines as ground contact. The integration of the identification unit in the sensor in the region of the connecting socket for the connecting cable makes possible simple housing and assembly as well as direct and simple contacting of the identification unit.

In an especially preferred embodiment of the invention the measuring signal of the sensor lies on a main contact of the connecting socket, which is encompassed essentially concentrically by a sleeve-shaped center contact and spaced apart through insulation whereby the center contact is connected to a first contact of the identification unit, and whereby the exterior contact is connected to the cable shield of the connecting cable, the ground contact of the sensor, and the second contact of the identification unit. This results in a plug design which is easy to manufacture and which can be reliably insulated and contacted. The actual measuring element can be responded to or queried through the main contact and through the cable shield of the connecting cable serving as ground contact. The identification unit can be contacted and queried through the center contact and the exterior contact that is connected to the cable shield of the connecting cable.

According to an additional preferred embodiment of the invention, the identification unit is arranged in a lateral recess in the region of the connecting socket between a housing part of the sensor that is connected to the exterior contact and the center contact, and whereby the identification unit is pressed against the center contact on the housing side by a biasing conductive spring. This results in a simple and space-saving arrangement of the identification unit (usually designed to be of very small dimensions) in the sensor in the region of the connecting socket whereby simple and reliable inquiry of the identification unit is possible through the direct contact and contact pressure of the conductive spring without the necessity of temperature-sensitive and vibration-sensitive soldering points or the like, for example.

In an additional embodiment of the invention, the connection contact can be directly formed by the connection threads of the connecting socket on the sensor housing, which simplifies the overall design of the connecting socket.

In an additional embodiment of the invention, the identification unit is formed by a resistor of a defined size being preferably at least nearly cylindrical and having conductive connectors in the area of its two end surfaces whereby said resistor characterizes the sensor sensitivity or the measuring range. Resistors of this type are simple, inexpensive, and robust mass-produced components which are easily and reliably housed and queried as an identification unit in the above-described manner in the region of the connecting socket of the sensor.

In the following, the invention is explained in more detail with the aid of the drawings.

### BRIEF DESCRIPTION OF THE DRAWINGS

FIG. 1 shows a cross section through the connection plug on the side of the connecting cable, and

FIG. 2 shows a corresponding cross section through the connection socket for the connecting cable on a sensor designed according to the invention.

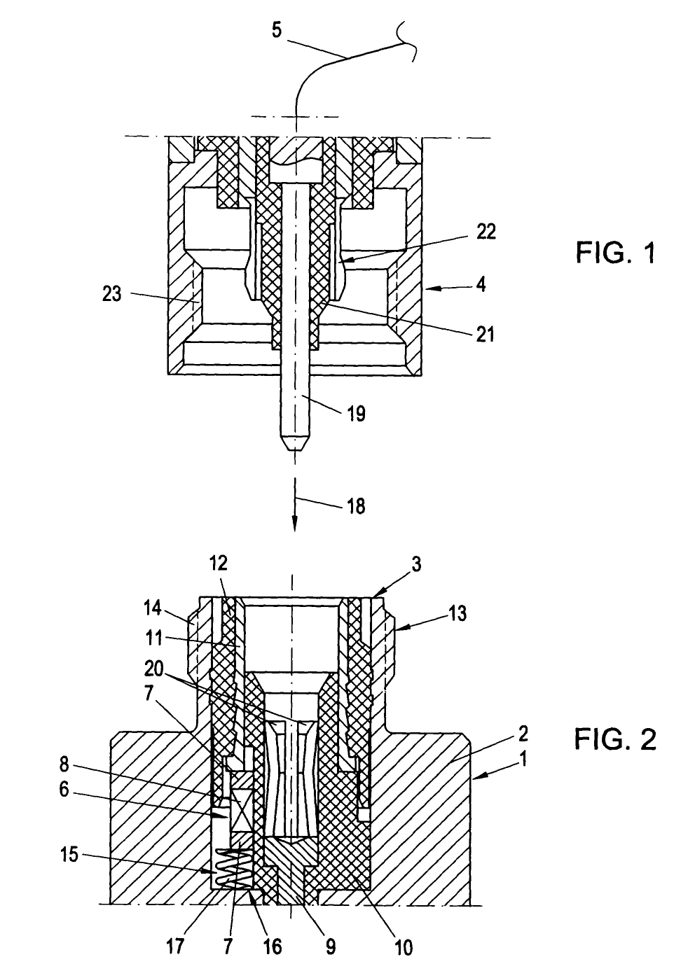

### DETAILED DESCRIPTION OF THE PREFERRED EMBODIMENT

The sensor 1 can be designed, for example, as a piezo-electric pressure sensor (not further illustrated) and said sensor 1 is provided with a housing 1 that accommodates a connection socket 3 on the illustrated upper end. If needed, a connecting cable 5 (only indicated here) can be plugged or screwed into the connecting socket 3 of the sensor 1 through the connecting plug 4 whereby the sensor 1 or its measuring element (not illustrated) communicates with an inquiry or evaluation unit (also not illustrated) on the end of the connecting cable 5.

The sensor 1 is provided with an integrated identification unit 6 in the region of the connecting socket 3 through which assistance sensor-relevant data can be queried via the connecting cable 5, such as the measuring range or the sensor sensitivity, for example, and which makes possible consideration of this data during the process of measuring or evaluation of the measured results. In the present case, the identification unit 6 is formed by a resistor 8 of a defined size characterizing sensor sensitivity or measuring range, for example, whereby the resistor 8 is provided with conductive contacts 7 in the area of its two end surfaces.

The measuring signal of the measuring element of the sensor 1 (not illustrated) lies on a main contact 9 of the connecting socket 3, which is encompassed by a center contact 11 that is connected in the illustration to the upper contact 7 of the resistor or the identification unit 6 whereby the center contact 11 has the shape of a sleeve and concentrically encompasses the main contact 9 while being spaced apart by the insulation 10. This center contact 11 is concentrically encompassed itself by a ground contact of the measuring element of the sensor 1 while being spaced apart by the insulation sleeve 12 whereby the lower contact 7 of the resistor 8 in the illustration or the exterior contact 13 is connected to the identification unit 6, and whereby the exterior contact 13 is formed here directly on the sensor 1 by the connecting threads 14 of the connecting socket 3 disposed on the housing 3 of the sensor 1. The identification unit 6 (or the resistor 8) is arranged in a lateral recess 15 of the insulation 10 in the region of the connecting socket 3 between a housing part (shoulder 16) of the sensor 1 and the center contact 11, and the identification unit 6 is pressed against the center contact 11 at the housing side by means of a conductive biasing spring 17.

The center contact pin 19 comes into conductive contact with the contact prongs 20 of the main contact 9 during plugging-in or screwing-in of the connecting plug 4 in direction of the arrow 18 into or onto the connecting socket 3 on the sensor side. The inner wall of the center contact 11 makes contact with the sleeve-shaped center contact 22 held at a distance to the contact pin 19 by the insulation 21 or with its contact prongs 20, and exterior contact is made through the threads 14 or through their engagement into the threads 23 of the connecting plug 4. The cable shield extends thereby past the threads 14 and 23 and continues to cover the connecting socket 3 on the sensor 1. Contacting and inquiry of the identification unit 6 or the resistor 8 can occur, on the one hand, through the cable shield being connected thereto via the threads 23, and through the center contact 22, on the other hand, which connects to a signal line of the dual-pole connecting cable 5. The measuring signal runs through the contact pin 19 or the other pole of the connecting cable connected thereto and through the cable shield or the threads 23 connected thereto.

I claim:

1. A sensor (1) having an identification unit (6) that can be queried electrically through a connecting cable (5), wherein the identification unit (6) is integrated in the sensor (1) in the region of the connecting socket (3) for the connecting cable (5) whereby the identification unit (1) is contacted through a separate pole of the connecting cable (5), on the one hand, and through the cable shield of the connecting cable (5), on the other hand.

2. A sensor according to claim 1, wherein the measuring signal of the sensor (1) lies on a main contact (9) of the connecting socket (3), which is encompassed essentially concentrically by a sleeve-shaped center contact (11) and spaced apart through insulation whereby said center contact (11) is connected to a first contact (7) of the identification unit (1), and whereby the exterior contact (13) is connected to the cable shield of the connecting cable (5), the ground contact of the sensor (1), and the second contact (7) of the identification unit.

3. A sensor according to claim 2, wherein the identification unit (6) is arranged in a lateral recess (15) in the region of the connecting socket (3) between a housing part (16) of the sensor (1) that is connected to the exterior contact (13) and the center contact (11), and whereby said identification unit is pressed against the center contact (11) on the housing side by a biasing conductive spring (17).

4. A sensor according to claim 3, wherein the exterior contact (13) is directly formed by the connection threads (14) of the connecting socket (3) designed on the sensor housing (2).

5. A sensor according to claim 4, wherein the identification unit (6) is formed by a resistor (8) of a defined size having conductive contacts (7) in the area of its two end surfaces whereby said resistor (8) characterizes the sensor sensitivity.
